(19) United States
(12) Patent Application Publication
(10) Pub. No.: US 2021/0279726 A1
(43) Pub. Date: Sep. 9, 2021

(54) INFORMATION PROCESSING APPARATUS AND COMPUTER PROGRAM

(71) Applicant: SONY CORPORATION, Tokyo (JP)

(72) Inventors: MASATO KITA, KANAGAWA (JP); DAISUKE ITO, TOKYO (JP)

(21) Appl. No.: 16/332,604

(22) PCT Filed: Sep. 25, 2017
(86) PCT No.: PCT/JP2017/034580

§ 371 Date: Mar. 12, 2019

(30) Foreign Application Priority Data
Oct. 21, 2016 (JP) 2016-206445

(51) Int. Cl. G06Q 20/40; G06Q 20/38

(52) U.S. Cl. CPC G06Q 20/401; G06Q 2220/00; G06Q 20/3829

(57) ABSTRACT

[Object] To improve security of the electronic money system. [Solution] An information processing apparatus including: a reception unit configured to receive information associated with value having monetary value in a payment system from a first storage device including a storage unit configured to store the information associated with the value, and to receive payment system identification information used to identify a payment system from a second storage device including a storage unit configured to store the payment system identification information; and a determination unit configured to perform determination of payment processing by using the information associated with the value and the payment system identification information.

### TECHNICAL FIELD

The present disclosure relates to an information processing apparatus and a computer program.

### BACKGROUND ART

Electronic money using contactless cards (e.g., IC cards) equipped with a storage device or using mobile communication terminals, and more widely, electronic payment systems regarding value having monetary value become widespread nowadays. It is possible for the user to perform payment for electronic money by holding a card or mobile communication terminal that supports electronic money payment over a reader that is a reading device.

Patent Literature 1 discloses a payment system using electronic money described above. Patent Literature 1 discloses a payment system in which a user performs payment for electronic money for performing electronic money payment using a single IC card.

### CITATION LIST

### Patent Literature

Patent Literature 1: JP 2008-65620A

### DISCLOSURE OF INVENTION

### Technical Problem

In the electronic money payment system disclosed in Patent Literature 1 described above, a single IC card is used for electronic money payment, so it is vulnerable to security. In other words, in a case where the relevant IC card is stolen, the person who stolen the relevant IC card is more easily likely to perform payment using the stolen IC card. In view of this, the present disclosure provides an information processing apparatus with higher security in electronic money payment.

### Solution to Problem

According to the present disclosure, there is provided an information processing apparatus including: a reception unit configured to receive information associated with value having monetary value in a payment system from a first storage device including a storage unit configured to store the information associated with the value, and to receive payment system identification information used to identify a payment system from a second storage device including a storage unit configured to store the payment system identification information; and a determination unit configured to perform determination of payment processing by using the information associated with the value and the payment system identification information.

In addition, according to the present disclosure, there is provided an information processing apparatus including: a reception unit configured to receive an identification information issuance request for requesting an issuance of identification information used for payment processing in a payment system; and an identification information issuance unit configured to issue identification information associated with a predetermined group to a first storage device in response to the identification information issuance request.

In addition, according to the present disclosure, there is provided a computer program including: causing a reception unit to receive identification information associated with value having monetary value in a payment system from a first storage device including a storage unit configured to store the identification information; causing the reception unit to receive payment system identification information specific to each payment system from a second storage device including a storage unit configured to store the payment system identification information; and further causing a determination unit to perform determination of payment processing by using the identification information and the payment system identification information.

### Advantageous Effects of Invention

According to the present disclosure as described above, it is possible for the user to use the payment system with higher security.

Note that the effects described above are not necessarily limited. With or in the place of the above effects, there may be achieved any one of the effects described in this specification or other effects that may be grasped from this specification.

### BRIEF DESCRIPTION OF DRAWINGS

FIG. 1 is a diagram illustrating an example of processing in an electronic money payment system for comparison with an electronic money payment system according to an embodiment of the present disclosure.

FIG. 2 is a block diagram illustrating an example of a configuration of an electronic money system according to an embodiment of the present disclosure.

FIG. 3 is a diagram illustrating an example of processing in the electronic money payment system according to an embodiment of the present disclosure.

FIG. 4 is a diagram illustrating a relationship between a group account and a group card according to an embodiment of the present disclosure.

FIG. 5 is a block diagram illustrating an example of a configuration of the electronic money system according to an embodiment of the present disclosure.

FIG. 6 is a diagram illustrating an example of identification information issuance processing in the electronic money payment system according to an embodiment of the present disclosure.

FIG. 7 is a diagram illustrating an example of processing in the electronic money payment system according to an embodiment of the present disclosure.

FIG. 8 is a diagram illustrating an example of identification information issuance processing in the electronic money payment system according to an embodiment of the present disclosure.

FIG. 9 is a diagram illustrating an example of a table relating to association with identification information managed by a server in an embodiment of the present disclosure.

FIG. 10 is a diagram illustrating an example of processing in the electronic money payment system according to an embodiment of the present disclosure.

FIG. 11 is a diagram illustrating an example of a table relating to association with identification information managed by a server in an embodiment of the present disclosure.

FIG. 12 is a diagram illustrating an example of a table relating to association with identification information managed by a server in an embodiment of the present disclosure.

FIG. 13 is a block diagram illustrating an example of a configuration of the electronic money system according to an embodiment of the present disclosure.

FIG. 14 is a diagram illustrating an example of key information issuance processing in the electronic money payment system according to an embodiment of the present disclosure.

FIG. 15 is a diagram illustrating an example of a table relating to an association relationship between identification information and key information managed by a server in an embodiment of the present disclosure.

FIG. 16 is a diagram illustrating an example of a table relating to an association relationship between identification information and key information managed by a server in an embodiment of the present disclosure.

FIG. 17 is a diagram illustrating an example of processing in the electronic money payment system according to an embodiment of the present disclosure.

FIG. 18 is a diagram illustrating an example of processing in the electronic money payment system according to an embodiment of the present disclosure.

FIG. 19 is a diagram illustrating an example of processing in the electronic money payment system according to an embodiment of the present disclosure.

FIG. 20 is a diagram illustrating an example of processing in the electronic money payment system according to an embodiment of the present disclosure.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Moreover, the description will be given in the following order.
0. Example of processing in payment system performing payment with one contactless card
1. Configuration example of payment system according to present disclosure
2. Example of processing in payment system according to present disclosure
3. Payment system using group account
3-1. Overview of payment system using group account
3-2. Configuration example of payment system using group account
3-3. Issuance of identification information in payment system using group account
3-4. Example of processing in payment system using group account
3-5. Another example of processing in payment system using group account
4. Payment system using key information
5. Supplement
6. Concluding remarks
   <<0. Example of Processing in Payment System Performing Payment with One Contactless Card>>

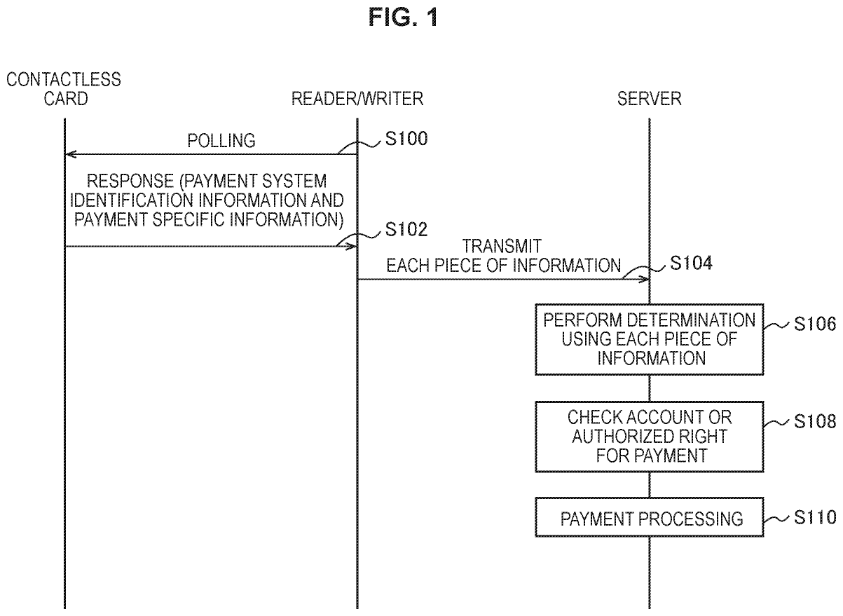

FIG. 1 is a diagram illustrating an example of processing in a payment system for comparison with a payment system according to an embodiment of the present disclosure that will be described later. The electronic money payment system is divided into a prepaid system and a postpaid system depending on the payment method. FIG. 1 illustrates processing when payment is performed in a server that performs payment processing using electronic money in both systems. The processing example illustrated in FIG. 1 may be, in one example, processing in a case where payment is performed for recharging value such as electronic money in a contactless card. In addition, the processing example illustrated in FIG. 1 may be a processing example when the value is deducted from an account associated with a contactless card.

Initially, in S100, a reader/writer sends a polling command and enters waiting state for a response from a contactless card. Then, in S102, the contactless card transmits payment system identification information and payment specific information to the reader/writer. Here, the payment system identification information is identification information indicating that it corresponds to a predetermined payment system in a plurality of payment systems. In one example, the payment system identification information is identification information indicating that it corresponds to the payment system of Edy (registered trademark). In addition, the payment specific information is information including symbols, numbers, or the like specific to the predetermined payment system indicated by the payment system identification information. In one example, the payment specific information is an Edy number in the Edy payment system. Moreover, the payment specific information is an example of information associated with value (e.g., electronic money) having monetary value in the electronic payment system.

Then, in S104, the reader/writer transmits the payment system identification information and the payment specific information, which are received from the contactless card, and information used for payment such as payment amount to the server. Then, in S106, the server determines whether or not the payment specific information received in a payment system indicated by the received payment system identification information is valid or the like.

In a case where the server determines in S106 that a payment specific number is valid, then the server checks account information in S108. In one example, the server checks that the electronic money is not insufficient in the account regarding the electronic money associated with the payment specific number or the like. In addition, the server checks that the payment amount does not reach the upper limit of the usage amount that is set in the payment specific number or the like. Then, in S110, the server performs payment processing. Moreover, in the above description, the server performs the processing of S106, S108, and S110. However, these processing operations may be performed by the reader/writer.

The above description is given of the payment processing in the electronic money payment system that performs payment with one contactless card. In the electronic money payment system that performs payment with one contactless card as described above, the payment is performed on the basis of information from one contactless card, which is vulnerable to security. Thus, in a case where the IC card is stolen, the person who stole the relevant IC card is easily likely to perform payment using the stolen IC card. Thus, the present disclosure provides a payment system that performs payment on the basis of information from a plurality of contactless cards. The configuration of the payment system according to the present disclosure is now described.

### <<1. Configuration Example of Payment System According to Present Disclosure>>

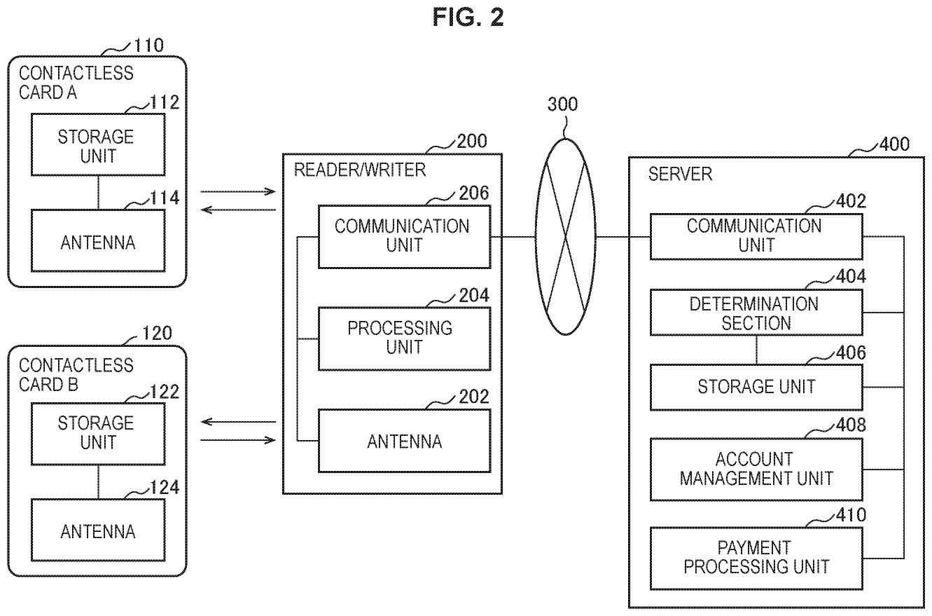

As illustrated in FIG. 2, the payment system of the present disclosure performs, in one example, payment processing on the basis of information from two contactless cards. The payment system of the present disclosure includes a plurality of contactless cards (contactless card A 110 and contactless card B 120), a reader/writer 200, and a server 400.

The contactless card A 110 and the contactless card B 120 have storage units 112 and 122, respectively and have antennas 114 and 124, respectively. The storage units 112 and 122 store information to be used in the payment system. The information stored in the storage units 112 and 122 is, in one example, the payment system identification information and the payment specific information as described above. In addition, information relating to value having monetary value such as electronic money may be stored in the storage units 112 and 122. In one example, the value may be a balance of electronic money recharged to the contactless card. Moreover, the storage units 112 and 122 may be IC chips.

The antennas 114 and 124 provided respectively in the contactless card A 110 and the contactless card B 120 are connected to the storage units 112 and 122, respectively, and are used to transmit the information stored in the storage units 112 and 122 to the reader/writer 200 by using electromagnetic waves emitted from the reader/writer 200. More specifically, the electromagnetic wave emitted from the reader/writer 200 passes through the interior of the antennas 114 and 124, which causes electric current to generate. The generated electric current activates the storage units 112 and 122 (IC chips), and the antennas 114 and 124 generate carrier waves using the generated electric current and transmit the information stored in the storage units 112 and 122 to the reader/writer 200.

The above description is given of the configuration of the contactless card. The configuration of the reader/writer 200 is now described. The reader/writer 200 includes an antenna 202, a processing unit 204, and a communication unit 206. The antenna 202 receives the electromagnetic wave sent from the contactless card and sends a signal to the processing unit 204. The processing unit 204 demodulates the signal received by the antenna 202, reads out the information transmitted from the contactless card, and sends it to the communication unit 206. The communication unit 206 transmits the information received from the processing unit 204 to the server 400 via a network 300. Moreover, the communication unit 206 may include a transmission unit that transmits information and a reception unit that receives information.

The above description is given of the configuration of the reader/writer 200. The configuration of the server 400 is now described. The server 400 includes a communication unit 402, a determination unit 404, a storage unit 406, a payment processing unit 410, and an account management unit 408. The communication unit 402 receives the information sent from the reader/writer 200 via the network 300 or transmits information to the reader/writer 200. Moreover, the communication unit 402 may include a transmission unit that transmits information and a reception unit that receives information.

The determination unit 404 performs determination to be used for payment on the basis of information received from the reader/writer 200. The determination unit 404 may perform the determination on the basis of the association relationship between pieces of information stored in the storage unit 406 as described later. The storage unit 406 stores the association relationship between various pieces of information used in the payment system as described above.

The account management unit 408 manages an account associated with value having monetary value in the payment system. Here, the value having monetary value in the payment system may be electronic money, point, or actual currency. The payment processing unit 410 performs payment processing on the basis of the determination by the determination unit 404 and the account management unit 408.

In FIG. 2, the server 400 is shown as a single component. However, the server 400 may be constituted as a server group having a plurality of servers depending on each function thereof. In one example, the server 400 may be constituted as a server group including a server having the determination unit 404, a server having the account management unit 408, and a server 400 having the payment processing unit 410. In addition, the server 400 may be constituted as a server group including the server 400 having the determination unit 404 and a server having the account management unit 408 and the payment processing unit 410. In addition, in a case where the server 400 is constituted as a server group having a plurality of servers, the servers may belong to their respective companies, organizations, or the like.

### <<2. Example of Processing in Payment System According to Present Disclosure>>

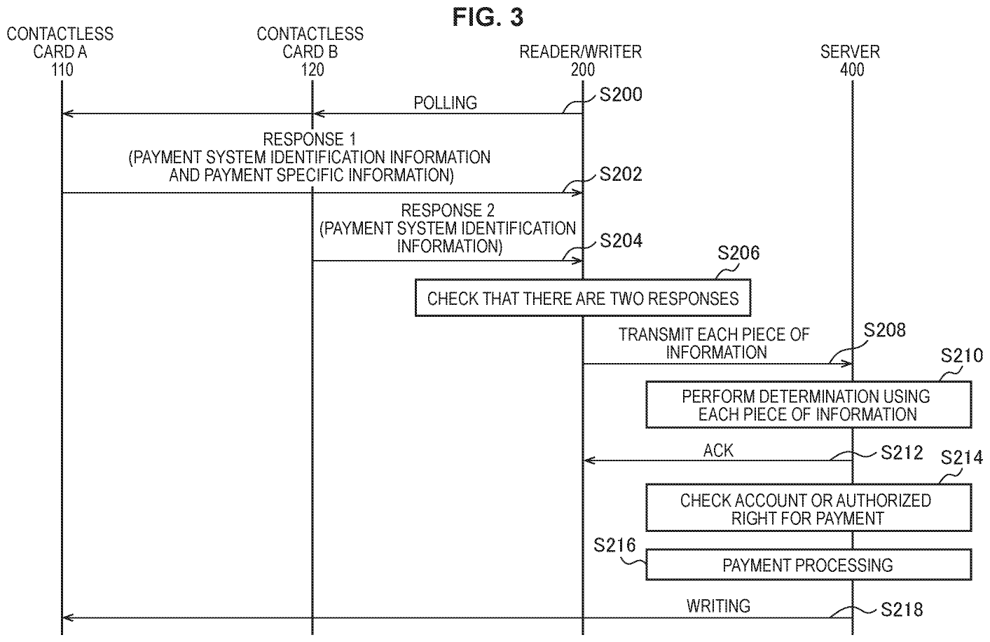

The above description is given of the configuration of the electronic payment system according to the present disclosure. An example of processing for payment in the electronic payment system according to the present disclosure is now described. FIG. 3 is a diagram illustrating an example of processing for payment in the electronic payment system according to the present disclosure.

Initially, in S200, the reader/writer 200 sends a polling command and enters waiting state for a response from the contactless card. Moreover, in the polling command, the responses from the two cards are processed at the same time, so a plurality of time slot values may be set. Then, in S202, the contactless card A 110 transmits the payment system identification information and the payment specific information stored in the storage unit 112 to the reader/writer 200. In addition, in S204, the contactless card B 120 transmits the payment system identification information stored in the storage unit 122 to the reader/writer 200. In this event, the reader/writer 200 is able to receive information from the contactless card A 110 and the contactless card B 120 if the user holds the contactless card A 110 and the contactless card B 120 over the reader/writer 200.

Then, in S206, the reader/writer 200 checks that there are two responses from the contactless cards 110 and 120. In S206, the reader/writer 200, when checking that there are two responses from the contactless cards, in S208, transmits the payment system identification information and payment specific information received from the contactless card A 110 to the server 400. In addition, in S208, the reader/writer 200 also transmits the payment system identification information received from the contactless card B 120 to the server 400. In addition, in S208, the reader/writer 200 may transmit information regarding a payment amount.

In S210, the determination unit 404 of the server 400 performs determination regarding payment using the payment system identification information and payment specific information received from the contactless card A 110 and the payment system identification information received from the contactless card B 120. In one example, the determination unit 404 determines whether or not the payment specific information received from the contactless card A 110 is valid in the payment system indicated by the payment system identification information received from the contactless card A 110. In addition, in one example, the determination unit 404 determines whether or not the payment system identification information received from the contactless card B 120 is payment system identification information of the payment system where the user intends to perform payment. In addition, it is determined whether or not the payment system identification information received from the contactless card A 110 is payment system identification information of the payment system where the user intends to perform payment. In other words, in a case where the user intends to perform payment using the Edy payment system, it is determined whether or not the payment system identification information received from the contactless card A 110 and the contactless card B 120 is payment system identification information indicating the Edy.

Then, in S212, in a case where the determination unit 404 determines that the payment specific information is valid and that the payment system identification information received from the contactless card B 120 the payment system identification information received from the contactless card A 110 are identical to each other, the communication unit 402 of the server 400 may send an acknowledgment (ACK) as a response to the reader/writer 200. Then, in S214, the account management unit 408 checks account information and/or an authorized right for payment. Then, in S214, in a case where the account management unit 408 checks that the value of the account is not insufficient for the payment amount or checks that the payment amount is within the range of the authorized right for payment, the payment processing unit 410, in S216, performs the payment processing.

After the payment processing unit 410, in S216, performs the payment processing, the server 400, in S218, may transmit an instruction to write information regarding payment including usage history, a balance of value such as electronic money, or the like to the contactless card. In addition, the above description is given of the processing of S210, S214, and S216 performed in the server 400. However, these processing operations may be performed by the reader/writer 200.

In the payment system according to an embodiment of the present disclosure as described above, information stored in a plurality of contactless cards is used for determination regarding payment. This allows a payment system with higher security to be constructed, as compared with the payment system performing payment with one contactless card. In addition, the user is able to perform payment with higher security by holding a plurality of contactless cards over the reader/writer 200 without entering an additional password or the like. Moreover, the above example uses two contactless cards for payment. However, the number of contactless cards used for payment is not limited to two, but may be three or more.

### <<3. Payment System Using Group Account>>

The above description is given of the basic configuration and processing of the payment system according to an embodiment of the present disclosure. The configuration and processing of a payment system using a group account common to a predetermined group are now described.

### <3-1. Overview of Payment System Using Group Account>

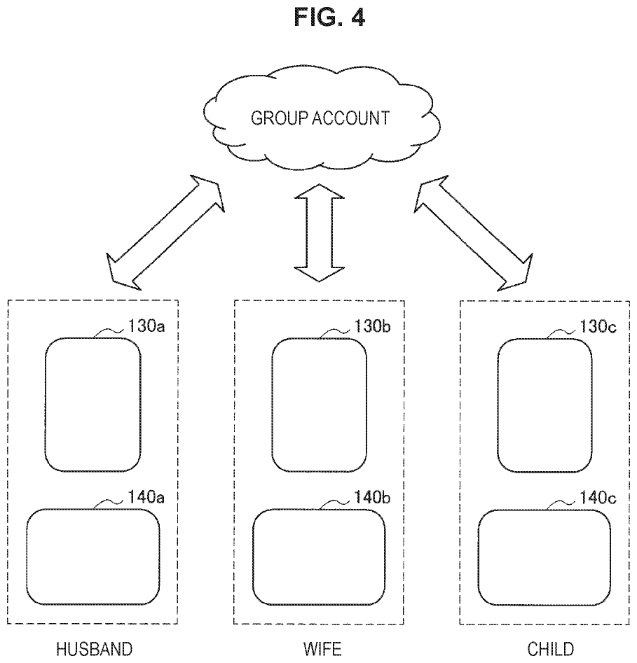

FIG. 4 is a diagram illustrating an overview of a payment system using a group account according to an embodiment of the present disclosure. The group account in the present disclosure is an account common to a predetermined group such as company, department, or family. In addition, the group account is an account that is set on a cloud, and in the present embodiment, the group account has the value in the payment system, so the contactless card owned by the user does not necessarily have the value for payment using the group account.

Further, in the present embodiment, the user performs payment using two contactless cards of a group card 130 and an individual card 140, as illustrated in FIG. 4. As will be described later, group identification information stored in the group card 130 is associated with the group account. Accordingly, in a case where a member in the group performs payment using the group card 130, the payment is performed for the group account, and value, for example, electronic money is deducted from the group account. Moreover, the group identification information is an example of information associated with value having monetary value in the electronic payment system (e.g., electronic money described above, or a group account associated with electronic money).

In FIG. 4, the predetermined group is a family, and the members of the group are three members of a husband, a wife, and a child. Then, the husband, wife, and child each have two contactless cards, i.e., the group card 130 and the individual card 140. The husband is able to perform payment for the group account using his own group card 130a and individual card 140a. In addition, the husband is also able to perform payment for the group account using his wife's group card 130b and his individual card 140a. In this way, the members of the group are able to perform payment for the group account using the individual card 140 of each member and the group card 130 of another configuration.

As described above, each member is able to perform payment using the group account common to members of the predetermined group. This makes it possible for the user to use a highly convenient payment system and for the manager of the group account to easily manage payment conditions within the group.

### <3-2. Configuration Example of Payment System Using Group Account>

The above description is given of the overview of the payment system using the group account according to an embodiment of the present disclosure. The configuration example of the payment system using the group account according to an embodiment of the present disclosure is now described.

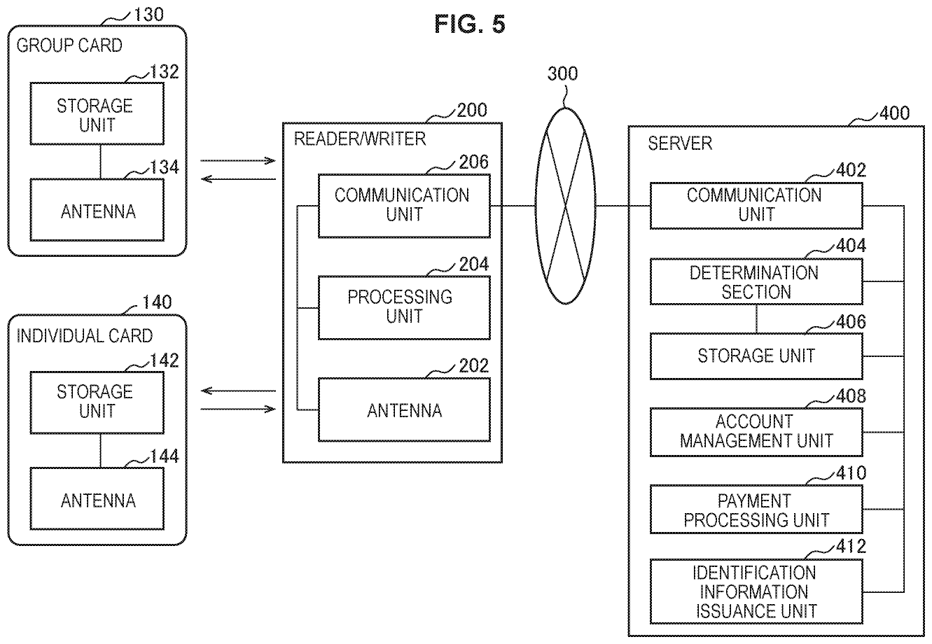

FIG. 5 is a diagram illustrating an example of a configuration of the payment system using the group account according to an embodiment of the present disclosure. In the payment system using the group account, payment is performed using two cards of the group card 130 and the individual card 140 as described above. The group card 130 has a storage unit 132 that stores group identification information associated with the group account described above, cloud enabled identification information indicating that the payment system using the group account is usable, and payment system identification information. In addition, the individual card 140 has a storage unit 142 that stores payment specific information and payment system identification information. Then, the server 400 further includes, in addition to the configuration described in FIG. 2, an identification information issuance unit 412 configured to issue the group identification information described above.

### <3-3. Issuance of Identification Information in Payment System Using Group Account>

The above description is given of the configuration example of the payment system using the group account. A way of issuing the group identification information in the payment system using the group account is now described.

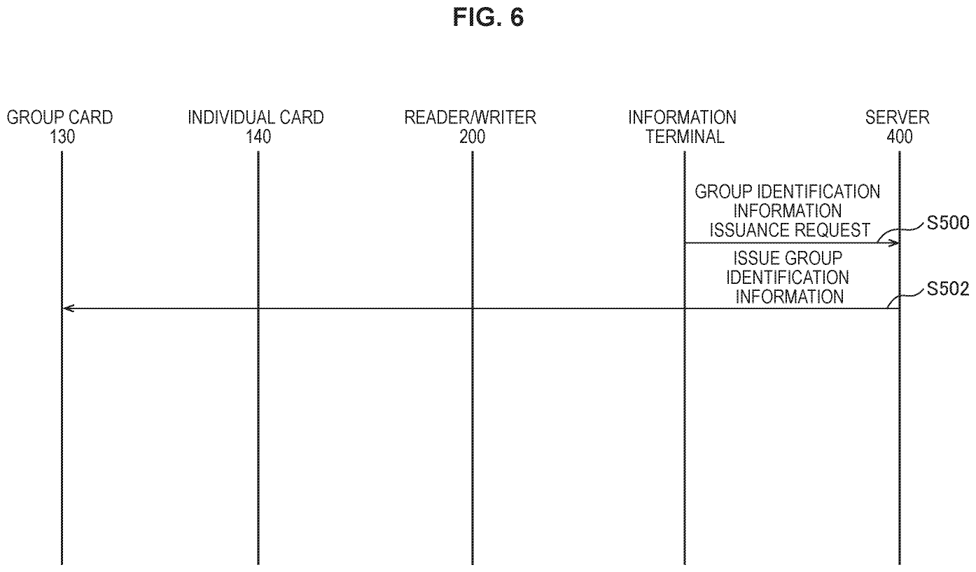

FIG. 6 is a diagram illustrating processing of issuing the above-described group identification information to the group card 130. The group identification information is issued to be associated with the group account as described above, and payment is performed for the group account using this group identification information in the payment system of the present embodiment.

In the issuance procedure of the group identification information in FIG. 6, initially, the user holds the group card 130 over an information terminal having a function of writing information on the IC chip of the contactless card and operates the information terminal so that the information terminal issues the group identification information to the server 400 (S300).

Then, in S302, the identification information issuance unit 412 issues the group identification information to the group card 130, and the group card 130 stores the issued group identification information in the storage unit 132. Then, the user performs the above-described processing for the plurality of group cards 130. In one example, in a case where the group identification information is issued to three group cards 130, the user may request the server 400 to issue the group identification information so that the group identification information is issued to three group cards 130 in advance. Then, the user sequentially holds the three group cards 130 over the information terminal, and stores the group identification information in the storage units 132 of the three group cards 130.

Moreover, the group identification information issued to a plurality of group cards 130 may be the same group identification information or may be different pieces of group identification information issued to each of the group cards 130. The server 400 may manage the association relationship between the group identification information and the group account in the form of a table.

### <3-4. Example of Processing in Payment System Using Group Account>

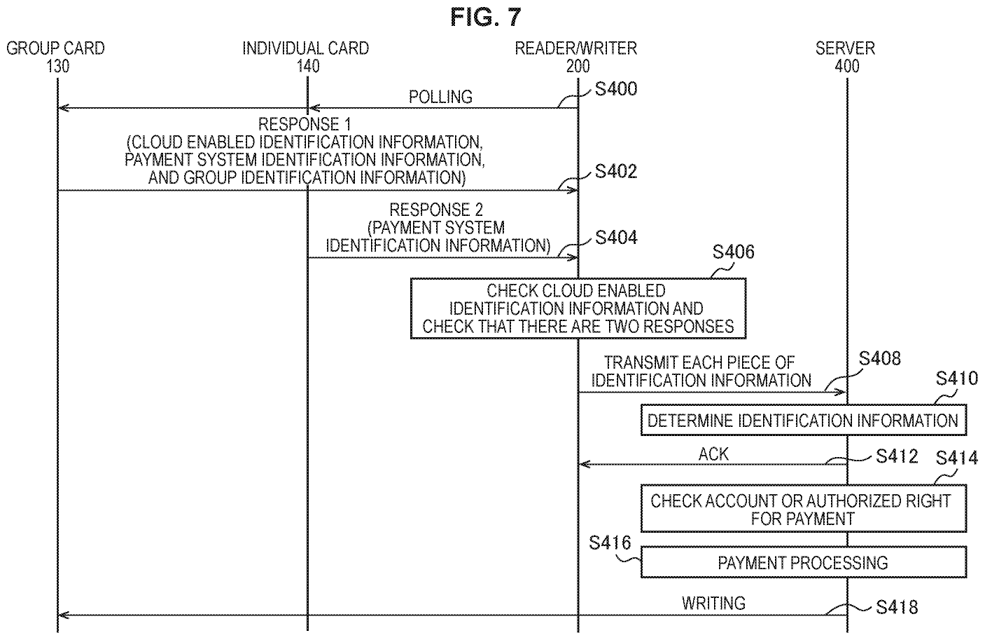

The above description is given of the way of issuing the group identification information in the payment system using the group account. An example of processing in the payment system using the group account is now described. FIG. 7 is a diagram illustrating an example of processing in the payment system using the group account.

Initially, in S400, the reader/writer 200 sends a polling command and enters waiting state for a response from the group card 130 and the individual card 140. Moreover, in the polling command, the responses from the two cards are processed at the same time, so a plurality of time slot values may be set. Then, in step S402, the group card 130 transmits the cloud enabled identification information, the payment system identification information, and the group identification information stored in the storage unit 132 to the reader/writer 200. In addition, in S404, the individual card 140 transmits the payment system identification information stored in the storage unit 142 to the reader/writer 200.

Then, in step S406, the reader/writer 200 checks that the cloud enabled identification information is received from the group card 130 and checks that there are two responses from the group card 130 and the individual card 140. In S406, the reader/writer 200, when checking the cloud enabled identification information and checking that there are two responses, in S408 transmits the payment system identification information and the group identification information received from the group card 130 to the server 400. In addition, in S408, the reader/writer 200 also transmits the payment system identification information received from the individual card 140 to the server 400. In addition, in S408, the reader/writer 200 may transmit information regarding the payment amount.

In S410, the determination unit 404 of the server 400 performs determination regarding payment, using the payment system identification information and the group identification information received from the group card 130 and the payment system identification information received from the individual card 140. In one example, the determination unit 404 determines whether or not the group identification information received from the group card 130 is valid or the like in the payment system indicated by the payment system identification information received from the group card 130. In addition, the determination unit 404 determines whether or not the payment system identification information received from the individual card 140 is identical to the payment system identification information received from the group card 130.

Then, in step S412, in a case where the determination unit 404 determines that the group identification information is valid in the payment system and the payment system identification information received from the individual card 140 is identical to the payment system identification information received from the group card 130, the communication unit 402 of the server 400 may send an acknowledgment (ACK) as a response to the reader/writer 200. Then, in step S414, the account management unit 408 checks the group account associated with the received group identification information and/or the authorized right for payment that is set for the received group identification information. Then, in step S416, the payment processing unit 410 performs payment processing.

After the payment processing unit 410 performs the payment processing in S416, the server 400, in S418, may transmit an instruction to write information regarding payment including usage history, a balance of value such as electronic money, or the like to the group card 130.

As described above, the payment is performed using the information stored in the group card 130 and the individual card 140, so there is provided the payment system with higher security than the payment system performing payment with one contactless card. In addition, the use of an account such as the group account associated with the predetermined group allows a more convenient payment system to be provided for the user.

### <3-5. Another Example of Processing in Payment System Using Group Account>

The above description is given of an example of the processing in the payment system using the group account. Another example of processing in which security is more enhanced in the payment system using the group account is now described.

In one example, in the above-described example, in the case where the group card 130 is stolen or the group card 130 is lost, payment is performed using the group card 130 and the individual card 140 of the payment system corresponding to the group card 130. In other words, the information transmitted from the individual card 140 in S404 of FIG. 7 is the payment system identification information, so if a person who stole or picked up the group card 130 has the individual card 140 corresponding to the same payment system, payment is performed using the stolen or picked-up group card 130. In order to prevent this situation, in an example of processing described below, it is determined whether or not the group identification information stored in the group card 130 and the payment specific information stored in the individual card 140 are associated with each other.

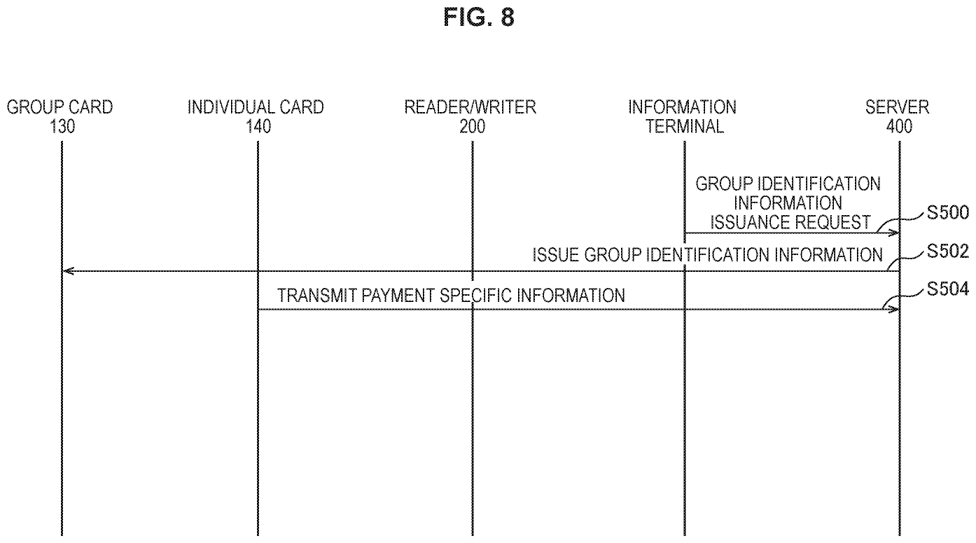

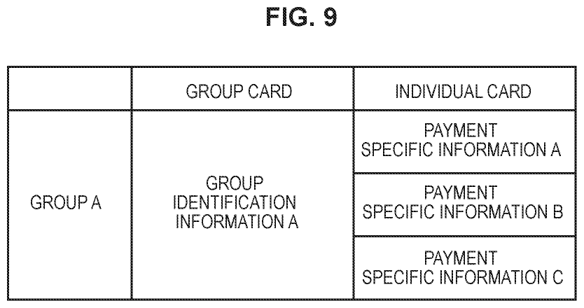

The association relationship between the group identification information and the payment specific information is stored and managed in the storage unit 406 of the server 400 by performing the processing of transmitting the payment specific information from the individual card 140 to the server 400 (S504) in the processing of issuing the group identification information as illustrated in FIG. 8. In other words, in the storage unit 406 of the server 400, the association relationship between a group account of a predetermined group A, group identification information A stored in the group card 130, and pieces of payment specific information A, B, and C stored in the individual card 140 is managed in the form of a table, as illustrated in FIG. 9. Moreover, FIG. 9 illustrates an example in which the same group identification information A is stored in the plurality of group cards 130.

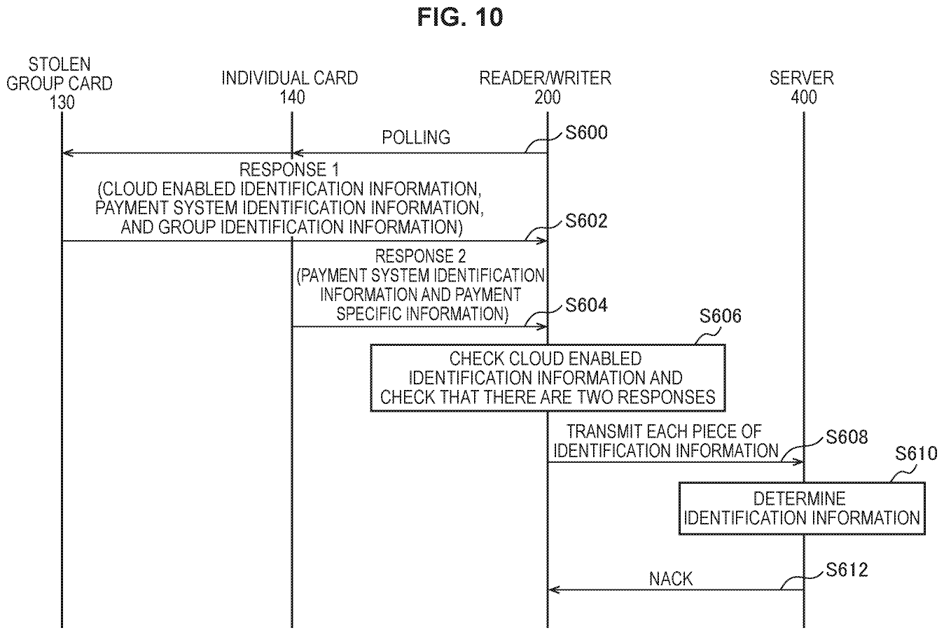

FIG. 10 is a diagram illustrating processing in the case where the group identification information and the payment specific information are managed in association with each other in the server 400 as illustrated in FIG. 9. In FIG. 10, the processing in the case where the group card 130 is stolen or the like is described. Moreover, S600, S602, and S606 in FIG. 10 respectively correspond to S400, S402, and S406 in FIG. 7, so the description thereof is omitted.

In the example of the processing illustrated in FIG. 10, in S604, the individual card 140 transmits the payment specific information. In step S608, the reader/writer 200 transmits the payment system identification information and the group identification information received from the group card 130 to the server 400. In addition, in step S608, the reader/writer 200 also transmits the payment system identification information and the payment specific information received from the individual card 140 to the server 400.

Then, in step S610, the determination unit 404 of the server 400 performs the determination regarding payment using the payment system identification information and group identification information received from the group card 130, and the payment system identification information and payment specific information received from the individual card 140. In one example, the determination unit 404 determines whether or not the group identification information received from the group card 130 is valid in the payment system indicated by the payment system identification information received from the group card 130. In addition, the determination unit 404 determines whether or not the payment system identification information received from the group card 130 is the payment system identification information of the payment system where the user intends to perform payment. In addition, the determination unit 404 determines whether or not the payment system identification information received from the individual card 140 is the payment system identification information of the payment system where the user intends to perform payment. In addition, the determination unit 404 determines whether or not the group identification information received from the group card 130 and the payment specific information received from the individual card 140 are associated with each other.

In the example of FIG. 10, the group card 130 is a stolen card, so in S610, the determination unit 404 determines that the group identification information received from the group card 130 is not associated with the payment specific information received from the individual card 140. Then, in step S612, the server 400 transmits a negative acknowledgment (NACK) to the reader/writer 200, and the processing ends.

As described above, in the processing example described with reference to FIG. 10, the payment specific information is transmitted from the individual card 140, and the determination unit 404 determines whether or not the group identification information and the payment specific information are associated with each other. Thus, even in a case where the group card 130 is stolen or the like, if the user does not have the individual card 140 corresponding to the stolen group card 130, the payment from the group account fails to be performed. This makes it possible to prevent incorrect payment using the group card 130 that is stolen or the like.

Moreover, in FIG. 9, the description is given of the table managed by the storage unit 406 of the server 400 in the case where the same group identification information is issued to the plurality of group cards 130. However, different pieces of group identification information may be issued to the plurality of group cards 130.

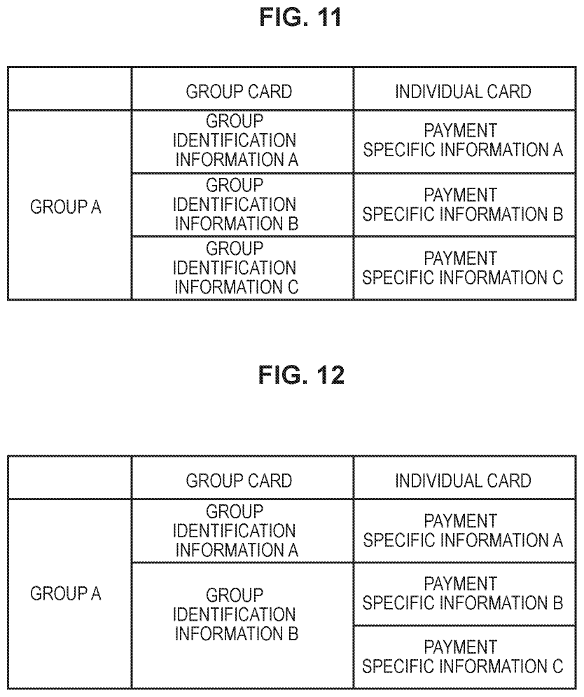

FIG. 11 is a diagram illustrating a table managed by the storage unit 406 of the server 400 in the case where different pieces of group identification information are issued to the plurality of group cards 130. As illustrated in FIG. 11, pieces of group identification information A, B, and C are associated with pieces of payment specific information A, B, and C, respectively, with respect to a group account of a predetermined group A.

The management of the group identification information and the payment specific information in this way makes it possible to perform payment using the group account of the group A with any combination of the group card 130 and the individual card 140 that respectively store the group identification information and the payment specific information, which are associated with each other in this table. In other words, the user is able to perform payment for the group account using the group card 130 having the group identification information A and the individual card 140 having the payment specific information A. In addition, the user is able to perform payment for the group account using the group card 130 having the group identification information A and the individual card 140 having the payment specific information B. In addition, the user is able to perform payment for the group account using the group card 130 having the group identification information A and the individual card 140 having the payment specific information C. Moreover, similarly, payment is performed for the group account with a combination of the group card 130 having the group identification information B or C and all the individual cards 140 managed by the table.

As described above, the user is able to perform payment with various combinations between the group cards 130 and the individual cards 140 managed by the table in the server 400, so a highly convenient payment system for the user is provided. In addition, the group identification information may be issued by giving different authorized rights for payment in the group account to different pieces of group identification information. In one example, the authorized rights for payment regarding different payment amounts may be given to different pieces of group identification information. In other words, the authorized right to perform payment of 10,000 yen per month may be given to the group identification information A. The authorized right to perform payment of 20,000 yen per month may be given to the group identification information B, and the authorized right to perform payment of 30,000 yen per month may be given to the group identification information C.

Further, the group identification information may be issued by giving the authorized right for payment regarding different number of times of payment in a predetermined period to different pieces of group identification information. In other words, the authorized right to perform payment three times per month may be given to the group identification information A. The authorized right to perform payment five times per month may be given to the group identification information B, and the authorized right to perform payment ten times per month may be given to the group identification information C.

Further, the group identification information may be issued by giving different authorized rights for payment regarding the number of times of payment and the payment amounts to different pieces of group identification information. In other words, the authorized right to perform payment three times per month for payment of 10,000 yen or more may be given to the group identification information A. The authorized right to perform payment five times per month for payment of 5,000 yen or more may be given to the group identification information B, and the authorized right to perform payment ten times per month for payment of 5,000 yen or more may be given to the group identification information C.

Further, as illustrated in FIG. 12, group identification information common to the plurality of individual cards 140 may be issued. In the example illustrated in FIG. 12, the group identification information A may be issued in association with the payment specific information A, and the group identification information B may be issued in association with pieces of payment specific information B and C.

As described above, different authorized rights for payment given to different pieces of group identification information allows the authorized right for payment matching the characteristics of the members of the group to be given. In one example, it is possible to prevent wasteful consumption of a child by presenting the child with the group card 130 having group identification information in which the authorized right for payment having less payment amounts and number of times of payment is given.

### <<4. Payment System Using Key Information>>

The above description is given of an example of the payment system using the group account. A payment system in which key information is further used is now described. The payment system identification information, the group identification information, and the payment specific information used for the payment described above are stored without being processed anything against eavesdropping and are transmitted, so these pieces of information are likely to be illegally extracted from the card. Then, those who illegally extracted these pieces of information can perform illegal payment using the contactless card in which these pieces of extracted information are stored. In order to prevent such a situation, in the example described below, the authentication using key information subjected to processing against eavesdropping is performed in the payment processing.

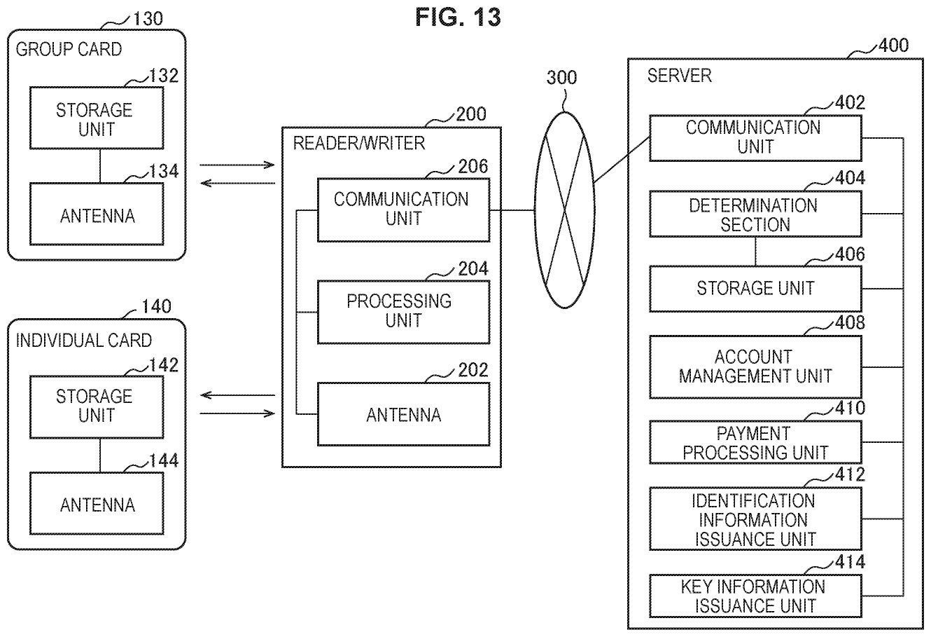

FIG. 13 is a diagram illustrating an example of a configuration of the payment system using key information that is subjected to processing against eavesdropping. In the payment system using key information, in one example, the key information is encrypted and stored in the storage unit 132 of the group card 130 and the storage unit 142 of the individual card 140 to cope with eavesdropping. Then, in addition to the configuration illustrated in FIG. 5, the server 400 also includes a key information issuance unit 414 that issues key information.

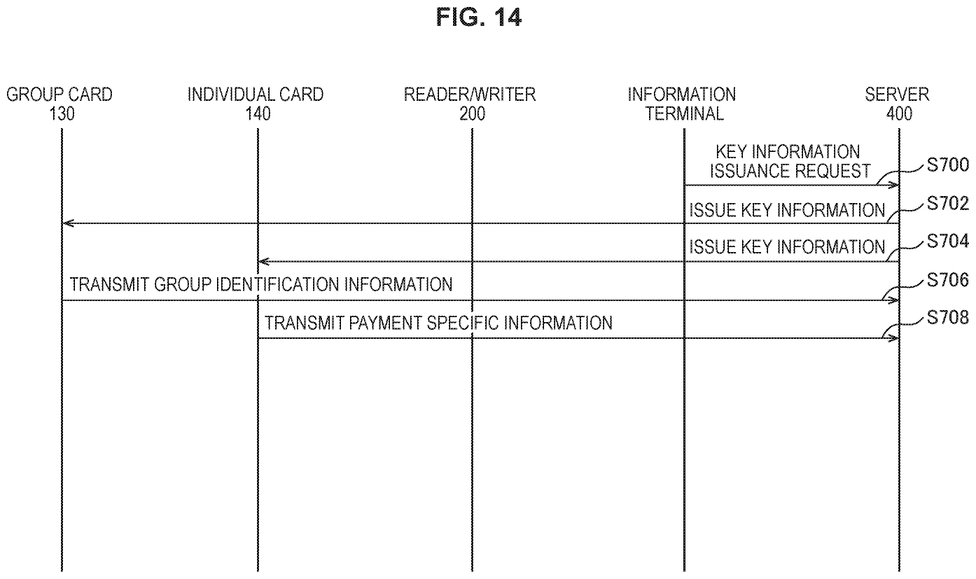

FIG. 14 is a diagram illustrating processing of issuing the above-described key information to the group card 130 and the individual card 140. In the issuance procedure of the key information in FIG. 14, initially, the user holds, in step S700, the group card 130 over an information terminal having a function of writing information on the IC chip of the contactless card and operates the information terminal so that the information terminal issues the key information to the server 400.

Then, in S702, the key information issuance unit 414 issues the key information to the group card 130, and the group card 130 stores the issued key information in the storage unit 132. Then, the user performs the above-described processing for the plurality of group cards 130. In one example, in a case where the same key information is issued to three group cards 130, the user may request the server 400 to issue the key information so that the key information is issued to three group cards 130 in advance. Then, the user sequentially holds the three group cards 130 over the information terminal, and stores the key information in the storage units 132 of the three group cards 130.

In addition, in S704, the key information issuance unit 414 issues the key information to the individual cards 140, and the individual cards 140 store the issued key information in the storage unit 142. Then, the user performs the above-described processing for the plurality of individual cards 140. Then, in step S706, the group card 130 transmits the group identification information to the server 400, and in step S708, the individual card 140 transmits the payment specific information to the server 400.

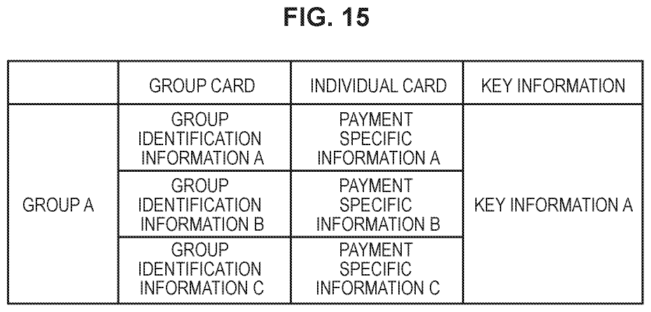

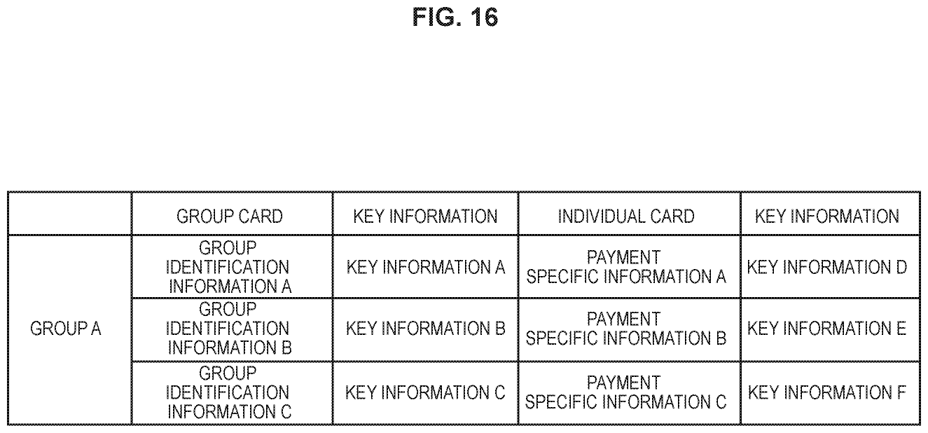

The issuance of the key information in this way allows the storage unit 406 of the server 400 to manage the predetermined group, the group identification information, the payment specific information, and the key information in association with each other as illustrated in FIG. 15. Moreover, in the example illustrated in FIG. 15, the same key information is issued to both the group cards 130 and the individual cards 140. However, as illustrated in FIG. 16, different pieces of key information may be issued to different group cards 130, and different pieces of key information may be issued to different individual cards 140.

In a case where different pieces of key information may be issued to different group cards 130 and different pieces of key information may be issued to different individual cards 140, a system with high security is possibly constructed. However, the issuance of the same key information to all the group cards 130 and the individual cards 140 reduces the number of pieces of key information to be issued, thereby reducing the volume of the key information (key value is smaller). This reduces the capacity for storing the key information in the server 400.

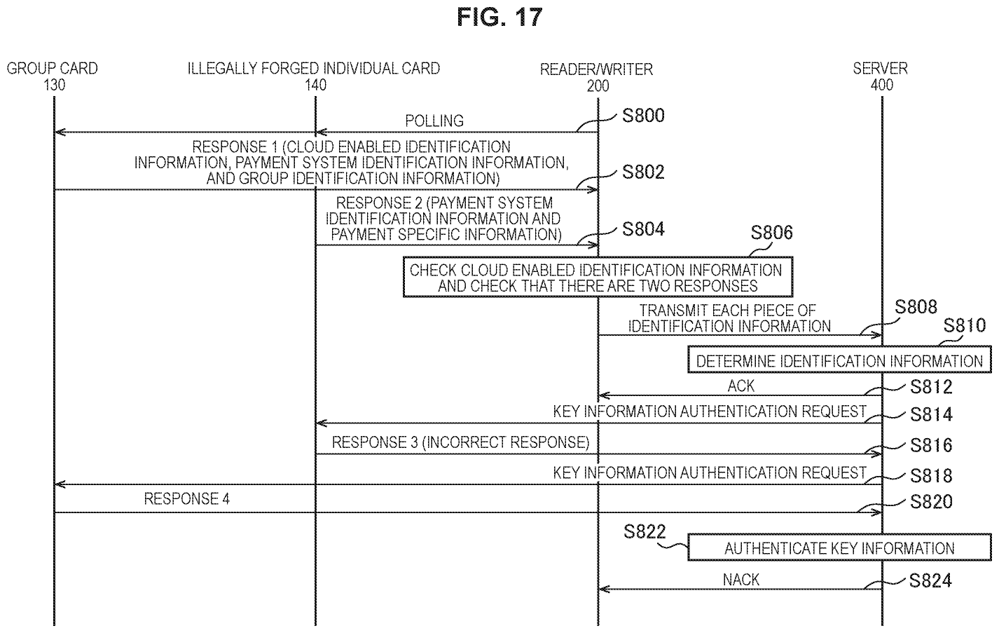

The above description is given of the way of issuing key information. The processing in the payment system using the key information is now described. Moreover, the following description is given of, as an example of the present embodiment, an example in which different pieces of key information are issued to different group cards 130 and different pieces of key information are issued to different individual cards 140 as illustrated in FIG. 16. In addition, in such a case, the set of key information issued to the group card 130 and the individual card 140 may be stored and managed in the storage unit 406 of the server 400. A case where the payment specific information stored initially in the individual card 140 as the processing of the payment system using the key information is illegally extracted is described with reference to FIG. 17. Moreover, S800 to S812 in FIG. 17 correspond to S600 to S612 in FIG. 10, so the description thereof is omitted.

In S810, if the determination unit 404 determines that the group identification information received from the group card 130 is associated with the payment specific information received from the individual card 140, the server 400 in S814 transmits an authentication request using the key information to the individual card 140. In addition, in step S818, the server 400 also transmits the authentication request using the key information to the group card 130. Here, the key information authentication requests in S814 and S818 may be encrypted and transmitted.

The individual card 140 in FIG. 17 is an illegally forged individual card 140, so it does not have correct key information. The reason why this forged individual card 140 does not have correct key information is that the key information is encrypted and stored in the individual card 140 to cope with eavesdropping as described above, and so it is not eavesdropped with ease. Here, the correct key information means key information associated with the key information stored in the group card 130.

As described above, the illegally forged individual card 140 does not have correct key information, so incorrect key information is transmitted to the server 400 or incorrect and inappropriate information is transmitted to the server 400 (S816). On the other hand, the group card 130 has correct key information, so the group card 130 transmits correct key information to the server 400 (S820). Then, in step S822, the determination unit 404 authenticates the key information. Here, the key information may be authenticated, in one example, by checking that the association relationship of the set of key information managed by the server 400 matches the association relationship of the key information received from the group card 130 and the individual card 140.

In the example of FIG. 17, the association relationship between the set of key information received from the group card 130 and the illegally forged individual card 140 and the set of key information stored in the server 400 is different, so the determination unit 404 fails to perform authentication using the key information (S822). Thus, in step S824, the server 400 transmits a negative acknowledgment (NACK) to the reader/writer 200, and the processing ends.

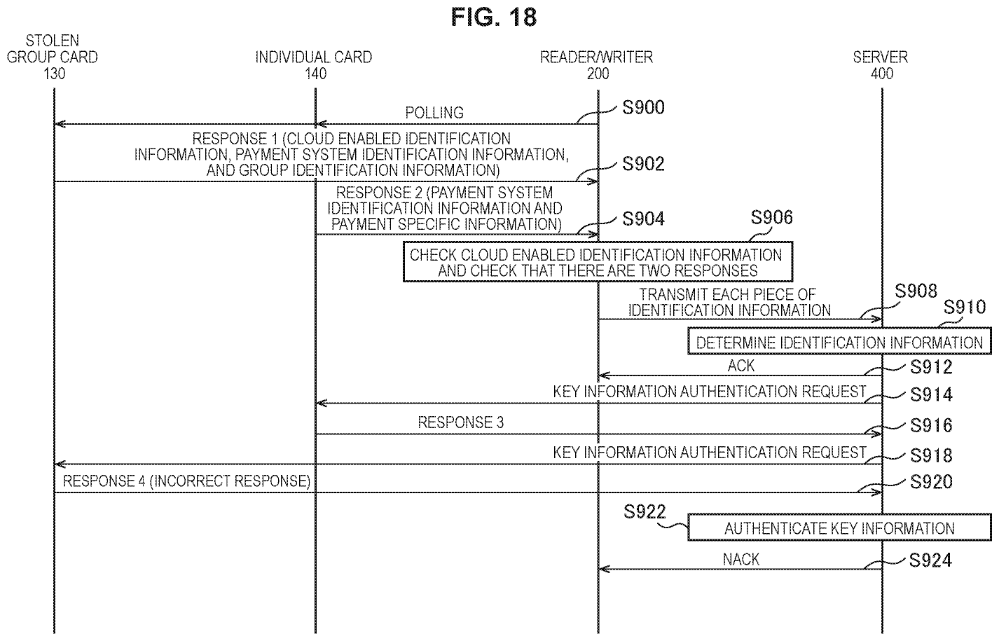

The above description is given of an example in which the individual card 140 is illegally forged. A case where the group card 130 is stolen is now described with reference to FIG. 18. Moreover, S900 to S912 in FIG. 18 correspond to S600 to S612 in FIG. 10, so the description thereof is omitted.

The server 400, in S914, transmits an authentication request using the key information to the individual card 140, which is similar to FIG. 17. In addition, the server 400, in step S918, also transmits the authentication request using the key information to the group card 130.

The individual card 140, in S916, transmits correct key information to the server 400, and the stolen group card 130 transmits incorrect key information to the server 400 (S920). Then, in step S922, the determination unit 404 authenticates the key information. However, the set of the key information received from the individual card 140 in S916 and the key information received from the stolen group card 130 in S920 is different in association relationship from the set of key information stored in the server 400, so the determination unit 404 fails to perform authentication using key information (S922). Thus, in step S924, the server 400 transmits a negative acknowledgment (NACK) to the reader/writer 200, and the processing ends.

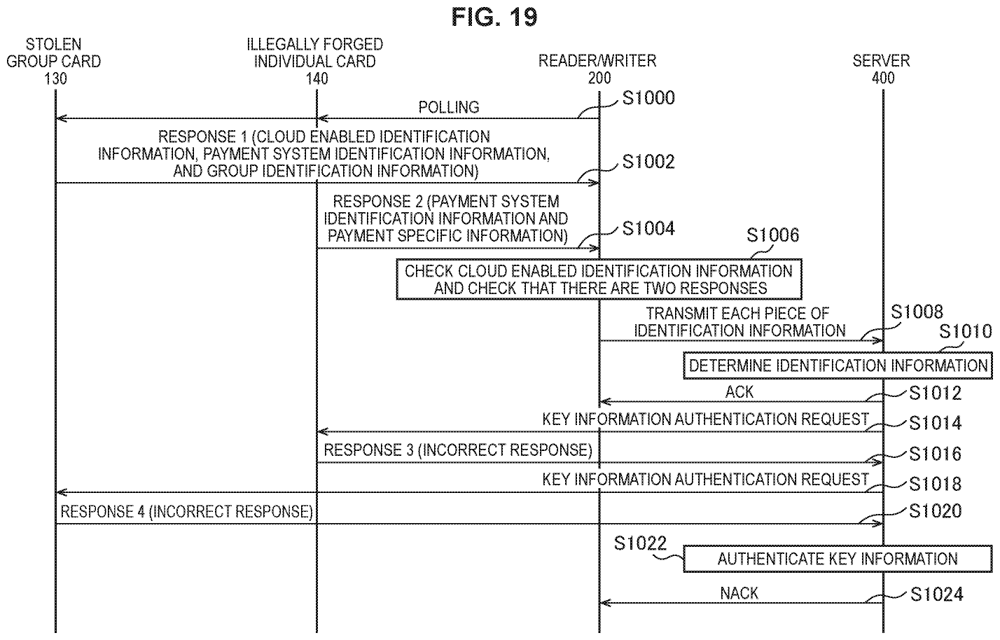

The above description is given of an example where the group card 130 is stolen. An example in which the group card 130 is stolen and the individual card 140 is illegally forged is now described with reference to FIG. 19. Moreover, S1000 to S1012 in FIG. 19 correspond to S600 to S612 in FIG. 10, so the description thereof is omitted.

The server 400, in S1014, transmits an authentication request using the key information to the individual card 140, which is similar to FIGS. 17 and 18. In addition, the server 400, in step S1018, also transmits the authentication request using the key information to the group card 130.

The illegally forged individual card 140, in S1016, transmits incorrect key information to the server 400, and the stolen group card 130 also transmits incorrect key information to the server 400 (S1020). Then, in step S1022, the determination unit 404 authenticates the key information. However, the set of the key information received from the illegally forged individual card 140 in S1016 and the key information received from the stolen group card 130 in S1020 is naturally different in association relationship from the set of key information stored in the server 400, so the determination unit 404 fails to perform authentication using key information (S1022). Thus, in step S1024, the server 400 transmits a negative acknowledgment (NACK) to the reader/writer 200, and the processing ends.

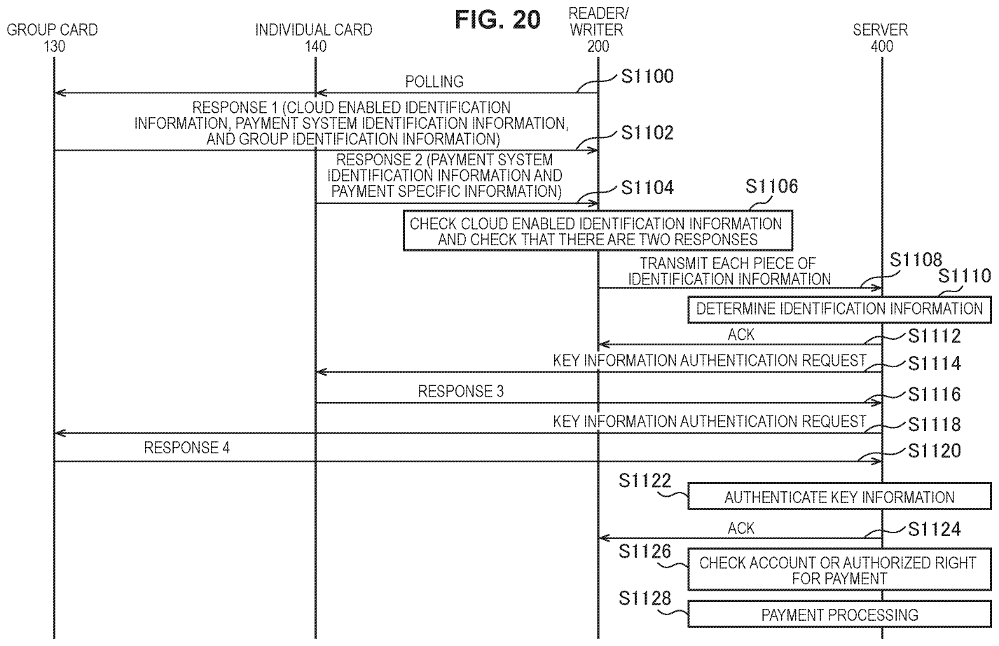

The above description is given of an example in which key information is used to prevent unauthorized payment. Then, an example in which authentication using key information is performed correctly is described with reference to FIG. 20. Moreover, S1100 to S1112 in FIG. 20 correspond to S600 to S612 in FIG. 10, so the description thereof is omitted.

In S1114 of FIG. 20, the server 400 transmits a key information authentication request to the individual card 140. Then, in step S1116, the individual card 140 that received the key information authentication request transmits the key information to the server 400. In addition, similarly, in step S1118, the server 400 transmits a key information authentication request to the group card 130. Then, in S1120, the group card 130 that received the key information authentication request transmits the key information to the server 400.

Then, in step S1122, the determination unit 404 performs authentication using the key information received from the individual card 140 in step S1116, and performs authentication using the key information received from the group card 130 in step S1120. In S1122, the set of key information received from the group card 130 and the individual card 140 has the same correct association relationship as the association relationship stored in the storage unit 406 of the server 400, so the authentication succeeds. Then, the processing proceeds to S1124, and the server 400 transmits an acknowledgment (ACK) to the reader/writer 200. In addition, in S1126, the account management unit 408 checks the group account associated with the group identification information received in S1108. In step S1128, the payment processing unit 410 performs the payment processing.

As described above, the use of the key information against eavesdropping makes it possible to prevent unauthorized payment even if some pieces of information are illegally extracted from the individual card 140 or the group card 130. Moreover, the encryption of the key information authentication request may be performed using the payment specific information received from the individual card 140 or the group identification information received from the group card 130 in S1108. In addition, the management of the correct association relationship of the key information by the server 400 allows unauthorized payment to be prevented from occurring in the case where the group card 130 or the individual card 140 is stolen. This provides a payment system with more advanced security protection with no use of additional information.

### <<5. Supplement>>

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

In one example, in the above example, a contactless card having information such as the payment system identification information, the payment specific information, or the group identification information stored therein is used for payment. However, a mobile communication terminal having these pieces of information stored therein may be used for payment. In this event, in one example, one mobile communication terminal and one contactless card may be used for payment.

Further, in the above example, as illustrated in FIGS. 9, 11, 15, and 16, the association relationship between the group identification information, the payment specific information, and the key information is stored and managed in the server 400. However, a table such as those illustrated in FIGS. 9, 11, 15, and 16 is stored in the storage unit of each contactless card, and each contactless card transmits the table to the server 400, thereby constructing the payment system that performs the above-described processing. In this case, the information of the key information can be reduced by using the same key information as described above, so it is possible to reduce the usage frequency for the key information in the storage unit of the group card 130 or the storage unit of the individual card 140.

Further, the above-described payment using a plurality of contactless cards is applicable to a payment system that recharges value having monetary value to a contactless card, or is applicable to a payment system that performs payment for value on a cloud like a group account. In addition, different pieces of payment system identification information may be given to a payment system that recharges value and a payment system that performs payment for value on a cloud. In one example, different pieces of payment system identification information may be given to the Edy payment system that recharges value to a contactless card and the Edy payment system that performs payment for value on a cloud.

Further, a computer program for causing the determination unit 404 and the payment processing unit 410 to operate as described above may be provided. In addition, a storage medium having such program stored therein may be provided.

### <<6. Concluding Remarks>>

As described above, in the payment system of the present disclosure, the user is able to perform payment processing using a plurality of contactless cards. This provides a payment system having higher security than a payment system performing payment with one contactless card.

Further, in the payment processing system according to the embodiment of the present disclosure, the user is able to perform payment processing using the group account. This makes it possible for members belonging to a predetermined group to perform payment for a common group account. In addition, different authorized rights for payment can be given to different pieces of group identification information, so it is possible to give an authorized right for payment depending on characteristics of the members in the group.

Further, in the payment processing system according to the embodiment of the present disclosure, the authentication using key information is performed. This makes it possible to prevent unauthorized payment even if some pieces of information are illegally extracted from the individual card 140 or the group card 130.

Further, the effects described in this specification are merely exemplified effects, and are not limitative. That is, with or in the place of the above effects, the technology according to the present disclosure may achieve other effects that are clear to those skilled in the art from the description of this specification.

Additionally, the present technology may also be configured as below.
(1) An information processing apparatus including:

a reception unit configured to receive information associated with value having monetary value in a payment system from a first storage device including a storage unit configured to store the information associated with the value, and

to receive payment system identification information used to identify a payment system from a second storage device including a storage unit configured to store the payment system identification information; and

a determination unit configured to perform determination of payment processing by using the information associated with the value and the payment system identification information.
(2) The information processing apparatus according to (1),

in which the information associated with the value is identification information associated with a predetermined group.
(3) The information processing apparatus according to (2),

in which the payment system is a payment system that performs payment for value on a cloud, and

the identification information associated with the predetermined group is associated with the value on the cloud.
(4) The information processing apparatus according to (2) or (3),

in which the second storage device further stores payment specific information that is specific to a predetermined payment system,

the reception unit receives the payment specific information from the second storage device, and

the determination unit determines whether or not the identification information associated with the predetermined group and the payment specific information, which are received, are associated with each other.
(5) The information processing apparatus according to any one of (2) to (4),

in which the identification information associated with the predetermined group includes a plurality of different pieces of identification information.
(6) The information processing apparatus according to (5),

in which different authorized rights for payment are given to the plurality of respective different pieces of identification information associated with the predetermined group.
(7) The information processing apparatus according to (6),

in which the different authorized rights for payment are authorized rights regarding a payment amount.
(8) The information processing apparatus according to any one of (1) to (7),

in which the first storage device and the second storage device further store encrypted key information, and

the information processing apparatus further includes a transmission unit configured to transmit an authentication request to request the encrypted key information.
(9) The information processing apparatus according to (8),

in which the transmission unit encrypts the authentication request using the identification information associated with the predetermined group or the payment specific information.
(10) The information processing apparatus according to (8) or (9),

in which the reception unit receives the key information from the first storage device and the second storage device, and

the determination unit performs authentication using the received key information.
(11) An information processing apparatus including:

a reception unit configured to receive an identification information issuance request for requesting an issuance of identification information used for payment processing in a payment system; and

an identification information issuance unit configured to issue identification information associated with a predetermined group to a first storage device in response to the identification information issuance request.
(12) The information processing apparatus according to (11),

in which the reception unit further receives a key information issuance request for requesting an issuance of encrypted key information, and

the information processing apparatus includes a key information issuance unit configured to issue the key information to the first storage device and a second storage device different from the first storage device in response to the key information issuance request.
(13) The information processing apparatus according to (11) or (12),

in which the identification information issuance unit issues identification information associated with one of the predetermined groups to the predetermined group.
(14) The information processing apparatus according to (11) or (12),

in which the identification information issuance unit issues identification information associated with a different plurality of the predetermined groups to the predetermined group.
(15) The information processing apparatus according to (14),

in which the identification information issuance unit issues identification information associated with the predetermined group by giving different authorized rights to of a plurality of respective different pieces of identification information associated with the predetermined group.
(16) A computer program including:

causing a reception unit to receive identification information associated with value having monetary value in a payment system from a first storage device including a storage unit configured to store the identification information;

causing the reception unit to receive payment system identification information specific to each payment system from a second storage device including a storage unit configured to store the payment system identification information; and

further causing a determination unit to perform determination of payment processing by using the identification information and the payment system identification information.

### REFERENCE SIGNS LIST

110, 120 contactless card
112, 122, 132, 142 storage unit
114, 124, 134, 144 antenna
130 group card
140 individual card
200 reader/writer
202 antenna
204 processing unit
206 communication unit
300 network
400 server
402 communication unit
404 determination unit
406 storage unit
408 account management unit
410 payment processing unit
412 identification information issuance unit
414 key information issuance unit

1. An information processing apparatus comprising:
a reception unit configured to receive information associated with value having monetary value in a payment system from a first storage device including a storage unit configured to store the information associated with the value, and
to receive payment system identification information used to identify a payment system from a second storage device including a storage unit configured to store the payment system identification information; and
a determination unit configured to perform determination of payment processing by using the information associated with the value and the payment system identification information.

2. The information processing apparatus according to claim 1,
wherein the information associated with the value is identification information associated with a predetermined group.

3. The information processing apparatus according to claim 2,
wherein the payment system is a payment system that performs payment for value on a cloud, and
the identification information associated with the predetermined group is associated with the value on the cloud.

4. The information processing apparatus according to claim 2,
wherein the second storage device further stores payment specific information that is specific to a predetermined payment system,
the reception unit receives the payment specific information from the second storage device, and
the determination unit determines whether or not the identification information associated with the predetermined group and the payment specific information, which are received, are associated with each other.

5. The information processing apparatus according to claim 2,
wherein the identification information associated with the predetermined group includes a plurality of different pieces of identification information.

6. The information processing apparatus according to claim 5,
wherein different authorized rights for payment are given to the plurality of respective different pieces of identification information associated with the predetermined group.

7. The information processing apparatus according to claim 6,
wherein the different authorized rights for payment are authorized rights regarding a payment amount.

8. The information processing apparatus according to claim 4,
wherein the first storage device and the second storage device further store encrypted key information, and
the information processing apparatus further includes a transmission unit configured to transmit an authentication request to request the encrypted key information.

9. The information processing apparatus according to claim 8,
wherein the transmission unit encrypts the authentication request using the identification information associated with the predetermined group or the payment specific information.

10. The information processing apparatus according to claim 8,
wherein the reception unit receives the key information from the first storage device and the second storage device, and
the determination unit performs authentication using the received key information.

11. An information processing apparatus comprising:
a reception unit configured to receive an identification information issuance request for requesting an issuance of identification information used for payment processing in a payment system; and
an identification information issuance unit configured to issue identification information associated with a predetermined group to a first storage device in response to the identification information issuance request.

12. The information processing apparatus according to claim 11,
wherein the reception unit further receives a key information issuance request for requesting an issuance of encrypted key information, and
the information processing apparatus includes a key information issuance unit configured to issue the key information to the first storage device and a second storage device different from the first storage device in response to the key information issuance request.

13. The information processing apparatus according to claim 11,
wherein the identification information issuance unit issues identification information associated with one of the predetermined groups to the predetermined group.

14. The information processing apparatus according to claim 11,
wherein the identification information issuance unit issues identification information associated with a different plurality of the predetermined groups to the predetermined group.

15. The information processing apparatus according to claim 14,
wherein the identification information issuance unit issues identification information associated with the predetermined group by giving different authorized rights to of a plurality of respective different pieces of identification information associated with the predetermined group.

16. A computer program comprising:
causing a reception unit to receive identification information associated with value having monetary value in a payment system from a first storage device including a storage unit configured to store the identification information;
causing the reception unit to receive payment system identification information specific to each payment system from a second storage device including a storage unit configured to store the payment system identification information; and
further causing a determination unit to perform determination of payment processing by using the identification information and the payment system identification information.
